(19) United States
(12) Patent Application Publication
(10) Pub. No.: US 2015/0088380 A1
(43) Pub. Date: Mar. 26, 2015

(54) ACTIVE TORQUE STEER COMPENSATION DURING NEGATIVE POWERTRAIN TORQUE FOR HYBRID AND ELECTRIC VEHICLES

(71) Applicant: FORD GLOBAL TECHNOLOGIES, LLC, DEARBORN, MI (US)

(72) Inventors: Daniel A. Gabor, Canton, MI (US); Kurt Mitts, Scotts, MI (US); John Walsh, Commerce Twp., MI (US)

(73) Assignee: FORD GLOBAL TECHNOLOGIES, LLC, DEARBORN, MI (US)

(21) Appl. No.: 14/035,012

(22) Filed: Sep. 24, 2013

(51) Int. Cl. B62D 6/00; B60L 7/10; B62D 5/04

(52) U.S. Cl. CPC B62D 6/001; B62D 5/046; B60L 7/10
USPC 701/41

(57) ABSTRACT

A system and method for compensating for drive influences of a drive train of a vehicle, where the vehicle has a traction motor and a power steering system including a servomotor configured to provide torque to a vehicle steering rack, include commanding the servomotor to apply a compensation torque to the vehicle steering rack. The compensation torque is applied in response to a predicted drive influence caused by a regenerative braking torque.

### TECHNICAL FIELD

This disclosure relates to systems and methods for compensating for drive influences of a drive train of an electric or hybrid vehicle on its steering system, in which the vehicle has an electric power steering system. A drive train simulation model which is integrated into the motor vehicle and permanently activated is used to determine disturbance variables from engine and regenerative braking behavior so that a compensation torque which counteracts the disturbance variables is generated for the power steering system.

### BACKGROUND

Vehicles that use a traction motor for propulsion (collectively “electric vehicles”, including plug-in electric and hybrid electric vehicles) may make use of regenerative braking During regenerative braking, a controlled load directly on the driveline imposes a torque in opposition to the direction of motion and converts kinematic energy into potential energy. Generally the mechanism for regenerative braking is a traction motor in conjunction with a battery, though other implementations capable of providing negative torque to the wheels and storing the generated energy are possible.

When a vehicle accelerates strongly it is possible to observe that motor vehicles with a driven front axle feel steering influences as a result of the engine forces. Similar steering influences with an opposite direction may be observed when a motor in an electric vehicle provides regenerative braking torque to vehicle traction wheels. According to convention, engine forces impose positive torque influences on the vehicle steering system and regenerative braking imposes negative torque influences on the vehicle steering system. Collectively, the positive and negative torque influences may also be referred to as drive or powertrain torque influences. The driver of the vehicle must actively intervene in order to counteract the generated steering force difference and to maintain the selected course. Some causes for these steering influences include secondary torques from the external constant velocity joints of the drive shafts if there are different bending angles on both sides of the vehicle; asymmetrical drive forces resulting from the friction in the differential gear mechanism; or a differential gear mechanism which is self-locking or locks in a controlled fashion or from forces of inertia. Furthermore, strong influences come from the geometric conditions of the front traction wheels with respect to the road surface, as a result of which the force application point of the tire force moves.

Powertrain influences, including engine influences and regenerative braking influences, could possibly have an adverse effect on a steering sensation of the driver of the vehicle such that the driver of the motor vehicle could find it to be an unacceptable nuisance during normal control of the motor vehicle. In particular for front wheel drive but also for all wheel drive vehicles, the steering sensation may be highly influenced by engine drive forces. These influences are a function of the system design and their intensity depends to a great extent on the front axle design, external influences, and the performance capability of the drive train. Because these perceived changes in the steering torque do not correspond to the natural feedback of the vehicle to a specific situation, they are perceived by the driver as a disturbance.

### SUMMARY

A system and method for compensating for drive influences of a drive train of a vehicle, in which the vehicle has a traction motor and a power steering system including a servomotor configured to provide torque to a vehicle steering rack, include commanding the servomotor to apply a compensation torque to the vehicle steering rack. The compensation torque is applied in response to a steering rack difference magnitude exceeding an associated threshold due to a regenerative braking event.

In some embodiments, the commanding the servomotor is further in response to a vehicle behavior model. The vehicle behavior model may be based on variables including regenerative braking torque, wheel speed, steering rack force, and steering wheel angle. In some embodiments, the servomotor is commanded to apply a torque with magnitude to compensate the difference between a calculated setpoint force at the vehicle steering rack and a measured force at the vehicle steering rack. In some embodiments, the associated threshold is a first predetermined threshold, and the commanding is further in response to a powertrain torque magnitude exceeding a second predetermined threshold and a magnitude of vehicle acceleration exceeding a third predetermined threshold. Various embodiments also include commanding the servomotor to apply a second compensation torque to the vehicle steering rack in response to the steering rack difference magnitude exceeding a second associated threshold due to an engine acceleration event.

A vehicle according to the present disclosure includes a power steering system configured to provide torque to a vehicle steering rack. The vehicle also includes a motor configured to apply regenerative braking torque to vehicle traction wheels. The vehicle additionally includes a controller configured to command the power steering system to provide a compensation torque in response to a steering rack difference magnitude exceeding an associated threshold due to a regenerative braking event.

In some embodiments, the controller is further configured to model vehicle behavior based on variables including regenerative braking torque, wheel speed, steering rack force, and steering wheel angle. In some embodiments, the controller is configured to command the power steering system to apply a compensation torque with magnitude to compensate the difference between a calculated setpoint force at the vehicle steering rack and a measured force at the vehicle steering rack. In other embodiments, the associated threshold is a first predetermined threshold, and the controller is further configured to command the power steering system to provide a compensation torque in response to a magnitude of vehicle acceleration exceeding a second predetermined threshold and a powertrain torque magnitude exceeding a third threshold. In other embodiments, the controller is further configured to provide a second compensation torque in response to the powertrain torque magnitude exceeding a second associated threshold due to an engine acceleration event.

A method of controlling a power steering system in a vehicle, where the vehicle has a traction motor, according the present disclosure includes commanding the power steering system to provide a first compensation torque in response to a powertrain torque exceeding a first predetermined threshold and a magnitude of a steering rack force difference exceeding a second threshold. The method additionally includes commanding the power steering system to provide a second compensation torque in response to the powertrain torque falling below a third predetermined threshold and the magnitude of the steering rack force difference exceeding a fourth predetermined threshold. The steering rack force difference is the difference between a calculated steering rack setpoint force and a measured steering rack force and the third threshold is less than the first threshold.

In some embodiments, commanding the power steering to provide the first compensation torque is further in response to a vehicle acceleration exceeding a fifth predetermined threshold and a vehicle speed exceeding a sixth predetermined threshold. In such an embodiment, commanding the power steering to provide the second compensation torque is further in response to the vehicle acceleration falling below a seventh predetermined threshold. The seventh threshold is less than the fifth threshold.

Embodiments according to the present disclosure may provide a number of advantages. For example, the present disclosure provides systems and methods for compensating for undesired drive influences caused by regenerative braking torque. Additionally, such systems and methods may remove such undesired drive influences from a driver's perception without removing desired feedback from contact between vehicle traction wheels and the road.

The above and other advantages and features of the present disclosure will be readily apparent from the following detailed description of the preferred embodiments when taken in connection with the accompanying drawings.

### BRIEF DESCRIPTION OF THE DRAWINGS

FIG. 1 is a schematic illustration of an electric vehicle including an electric toothed-rack power steering system,

FIG. 2 is a block diagram illustrating an operation calculating a steering force difference from engine or regenerative braking forces,

FIG. 3 is a block diagram illustrating an operation calculating a setpoint force at a toothed rack,

FIG. 4 is a block diagram illustrating an operation calculating a weight value for a synthetic setpoint toothed rack force,

FIG. 5 is a block diagram showing the inclusion of the calculated steering force difference, the setpoint force at the toothed rack and the weight value of the synthetic setpoint force in the power steering assistance,

FIG. 6 is a flowchart illustrating an embodiment of a method for controlling a power steering system to compensate for positive or negative drive influences, and

FIG. 7 is a flowchart illustrating another embodiment of a method for controlling a power steering system to compensate for positive or negative drive influences.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A vehicle electric power steering system (EPAS) uses a microprocessor and therefore can reach a specific “smart” operating level. This “smart” operating level makes it possible to adapt the steering properties of the motor vehicle to the requirements and operating conditions of the vehicle, the desires of the driver, or to actively counteract the disturbances.

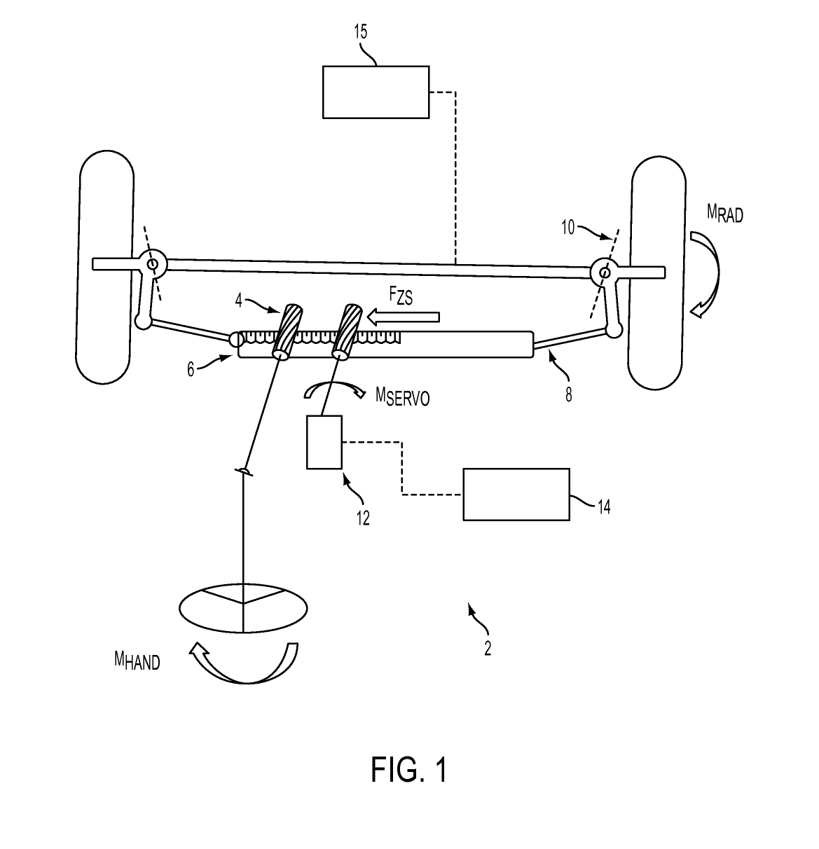

Referring now to FIG. 1, a schematic illustration of an electric vehicle 2 is shown. Electric vehicle 2 includes a toothed rack steering system with an EPAS (which may be referred to generally as a steering system). A driver may apply a steering wheel manual torque M_{hand}, which may be converted to a toothed rack force by means of a suitable gear mechanism 4. A toothed rack 6 is supported by means of track rods 8 on pivot bearings and controls the rotation of the wheels about a virtual steering axis 10. Track rods 8 apply a wheel steering torque M_{rad} to the steering system from the tire/underlying surface contact. A servomotor 12 acts on the toothed rack 6 to apply a steering assistance torque Mₛₑᵣᵥₒ. A controller 14 commands servomotor 12 to provide Mₛₑᵣᵥₒ to toothed rack 6 in response to various inputs. In a quasi-static case, the sum of steering wheel manual torque M_{hand} and assistance servo torque Mₛₑᵣᵥₒ compensates the torques of the wheels about the virtual steering axis M_{rad}. Electric vehicle 2 also includes a motor 15 configured to provide torque to vehicle fraction wheels.

Toothed rack force F_{ZS} is a function of the steering wheel manual torque M_{hand}, assistance torque of the servomotor Mservo, inertia, and friction. Fzs and other force variables may be measured by evaluating variables including drive engine torque, regenerative braking torque, and steering torque or force. Various sensors (not illustrated) may monitor these variables and provide input directly or indirectly to controller 14.

In general, wheel steering torques M_{rad} can be divided into those which are caused by forces at the tire contact area and those which arise from drive forces which act in the projection of the tire contact area onto the rotational axis of the wheel.

These forces generate a steering torque about the virtual steering axis, in each case with the corresponding lever arm. To increase driver satisfaction, only the forces at the tire contact area should be perceived in the steering wheel manual torque. In short, asymmetrical drive forces should be predicted and their influence on the steering system eliminated by the servomotor.

The distribution of the drive forces and regenerative braking forces among these wheels is calculated from available variables (usually available from the CAN bus) including engine torque, engine speed, regenerative braking torque, and wheel speeds of the traction and steering wheels. Given knowledge of the structurally conditioned geometric and kinematic relationships it is possible, while taking into account the steering wheel angle, to determine the influence of the engine forces and regenerative braking forces on the wheel steering torques and thus on the toothed rack.

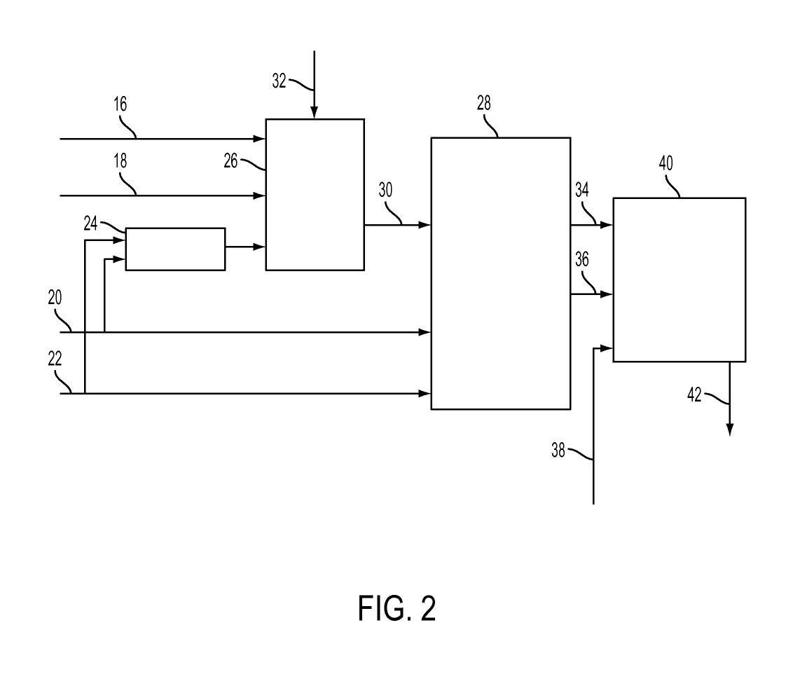

FIG. 2 shows the preferred signal flow. In FIG. 2, the reference numerals indicate the following:

16 Drive engine torque [Nm]

18 Drive engine speed [Nm]

20 Traction wheel speed, left hand [wheel/s]

22 Traction wheel speed, right hand [wheel/s]

24 Mean fraction wheel speed of 20 and 22

26 Axle torque calculation based on total gear mechanism transmission ratio

28 Model of differential gear mechanism/drive shafts

30 Powertrain axle torque [Nm]

32 Regenerative braking torque [Nm]

34 Wheel drive force, left hand [N]

36 Wheel drive force, right hand [N]

38 Steering wheel angle [wheel]

40 Model of axle kinematics/steering kinematics

42 Steering force difference calculated from powertrain forces

(The reference numerals 24, 26, 28, and 40 refer to model blocks and otherwise to signals.)

The drive engine torque 16, the drive engine speed 18, mean traction wheel speed 24, and regenerative braking torque 32 are input to torque calculation 26. Torque calculation 26 calculates a powertrain axle torque 30. Powertrain axle torque 30 is a signed value. In other words, axle torque 30 may be positive if dominated by engine torque or negative if dominated by regenerative braking torque. Powertrain axle torque 30 is supplied to the model 28. The model 28 corresponds to the permanently activated simulation model of the drive train. The traction wheel speeds 20 and 22 are also respectively supplied to the model 28. The model 28 generates the wheel drive force on the left hand and right hand sides, 34 and 36 respectively, which are supplied to the model 40. The steering wheel angle 38 is also supplied to the model 40. The steering force difference 42 is generated in the model 40. With knowledge of these exemplary influences, the interfering steering torques on account of the engine forces and regenerative braking forces are supported by the servomotor and cannot be perceived by the driver in the manual torque of the steering wheel.

In addition to the general case, it may be found that for specific operating points and configurations the calculations in the model of the differential gear mechanism/drive shaft 28 of the block diagram illustrated in FIG. 2 are not reliable. This applies in particular to small differences between the wheel speeds 20 and 22. In this case, the wheel drive forces on the left and right hand sides are assumed to be equally large.

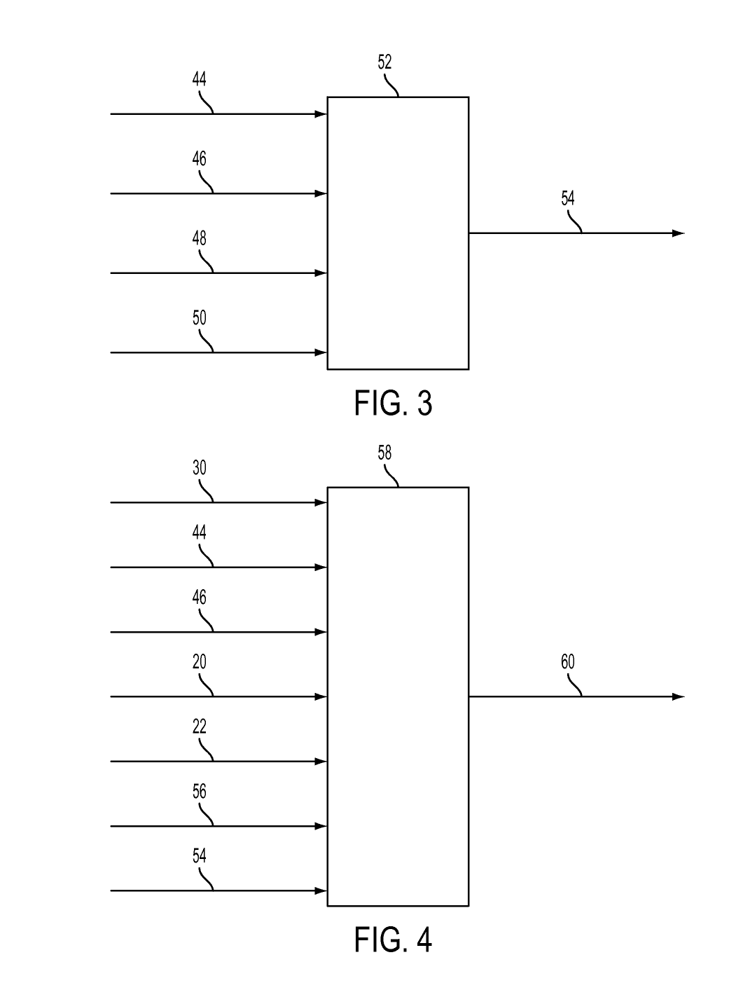

Furthermore, geometric irregularities, such as for example ruts, may occur in the contact between the tire and the underlying surface and can have mathematically unpredictable influences on the steering torque. For these cases, a setpoint force at the toothed rack is calculated from available variables (such as the CAN bus) in the developed algorithm, see in this respect also FIG. 3.

In FIG. 3, the reference numerals indicate the following:

44 Vehicle speed [km/h]

46 Lateral acceleration [m/s2]

48 Yaw rate [wheel/s]

50 Steering wheel speed [wheel/s]

52 Synthetic setpoint calculation of the toothed rack force-multidimensional characteristic diagram with correction functions

54 Setpoint force for the toothed rack [N]

The vehicle speed 44, the lateral acceleration 46, the yaw rate 48 and the steering wheel speed 50 are supplied to the setpoint value calculation means 52 which calculates the setpoint force 54 for the toothed rack. For this purpose, a characteristic diagram composed of vehicle data is developed and is input into the block 52. Alternately, the setpoint force at the toothed rack can also be formed from suitable mathematical equations with the same input variables instead of from this characteristic diagram. Instead of the yaw rate, the yaw acceleration can also serve as the input variable.

If the setpoint force at the toothed rack now differs from the actually occurring force in which the steering force difference has been corrected, and if further preconditions, such as for example a high axle drive torque or low differential speed between the traction wheels when cornering, are given in the driving situation, this setpoint force is also included in the calculation of the compensation torque. The servo assistance then applies a steering wheel compensating torque corresponding to a toothed rack force between the setpoint force and the actually occurring force.

The steering wheel manual torque which can be perceived by the driver is in principle based on the toothed rack force, irrespective of whether the servo assistance by the toothed rack force is calculated from an observer model, from a torque sensor in the steering column or by some other method. Preferably it is assumed that the servo assistance by means of the toothed rack force is generated from an observer model. The interfaces are to be correspondingly adapted for other cases.

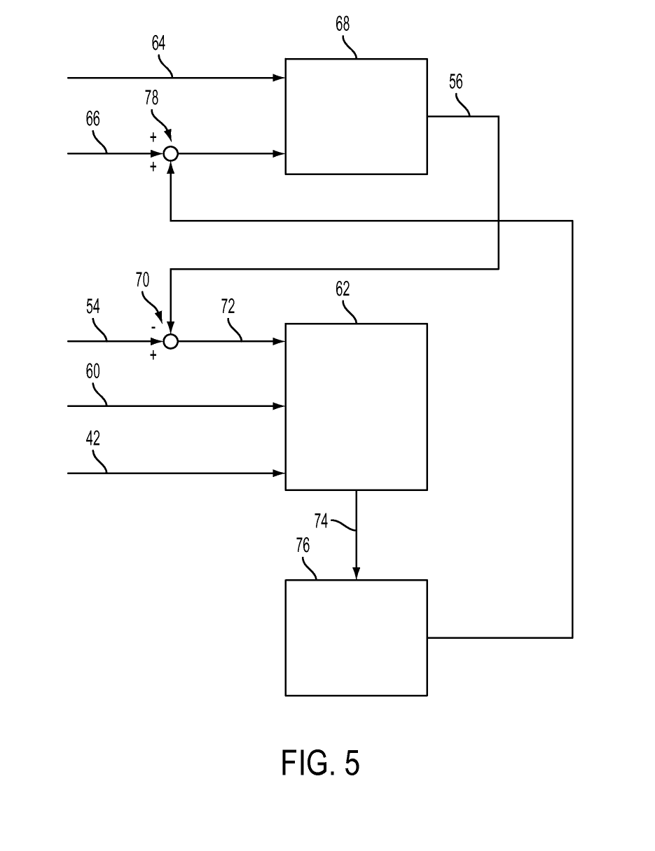

Referring now to FIG. 4, a switching function 58 is illustrated to smoothly transition among a steering wheel manual torque corresponding to the setpoint toothed rack force 54, an actual toothed rack force 56 in which the steering force difference is corrected, or an intermediate value. Switching function 58 outputs a weight value 60, varying from 0 to 1. Weight value 60 may be used to modify a toothed rack force correction factor, as will be described below in conjunction with FIG. 5. A weight value 60 equal to 0 corresponds with no applied toothed rack force correction, and a weight value 60 equal to 1 corresponds to a fully synthetically generated steering wheel manual torque, which does not permit any feedback of the tire/underlying surface contact but does not have any disturbance influences either.

In one embodiment, switching function 58 is tuned to generally output a weight value 60 of 0 for the sake of precise feedback of the contact relationships between the tire and underlying surface. Switching function 58 will increase weight value 60 only in cases in which interfering steering influences from drive forces have to be expected and the actual toothed rack force deviates from the setpoint force. In such situations, switching function 58 will increase weight value 60 progressively with respect to the deviation. Generally, as the driven axle torque or regenerative braking torque increase in magnitude, the probability of drive influences acting on the steering system becomes greater, and therefore the weight value is displaced more toward the synthetic setpoint force. As the speed of the vehicle increases, the weight value may be reduced to approach the actual toothed rack force, and the same applies to high lateral acceleration. If the steering wheel angle and lateral acceleration are opposed in sign, it can be assumed that countersteering, and thus a highly dynamic driving maneuver, is occurring. In this case, the actual toothed rack force is to be passed on in the sense of the feedback.

Referring now to FIG. 5, a schematic is shown illustrating calculation of compensation torque. Steering wheel manual torque 64 and EPAS servo torque 66 are input to block 68, in which actual toothed rack force 56 is calculated. Actual toothed rack force 56 is subtracted from toothed rack setpoint force 54 at operation 70 to output setpoint force difference 72.

Steering force difference 42, weight value 60, and setpoint force difference 72 are input to toothed rack force correction operation 62. As discussed above, weight value 60 may vary from 0, at which no correction is applied, to 1, at which full correction based on the synthetic setpoint is applied. Correction operation 62 outputs compensation signal 74. Compensation signal 74 is then converted to a compensation torque 76. Compensation torque 76 is applied by an EPAS servomotor. Returning to the operation, compensation torque 76 is summed with the previous EPAS servo torque 66 at operation 78.

For reasons of clarity, FIGS. 2 to 5 are illustrated separately from one another, and the block circuit diagrams can also be combined into a single one. FIGS. 2 to 4 illustrate how the input variables for the block 62 are generated.

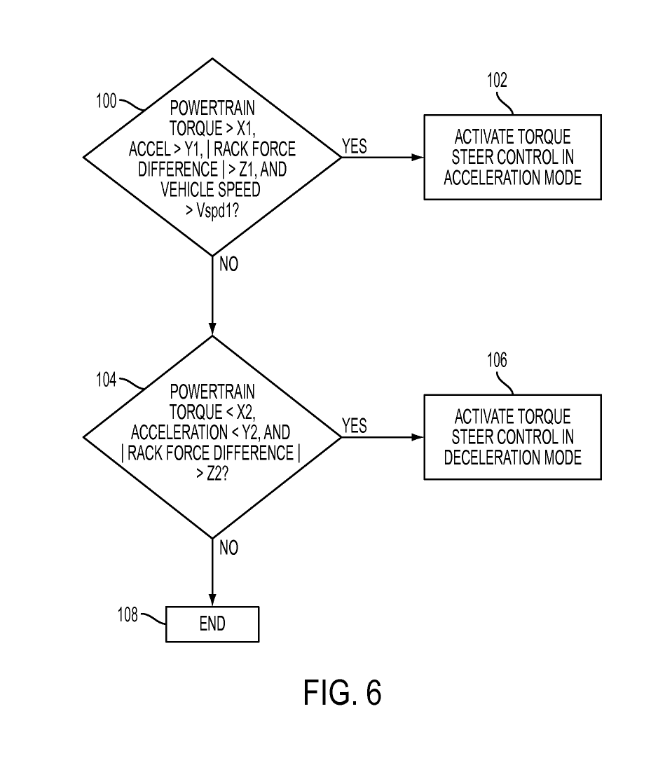

Referring now to FIG. 6, a flowchart illustrating an alternate embodiment of steering control logic is shown. At operation 100, a determination is made of whether a current powertrain torque exceeds a predetermined threshold X1, a vehicle acceleration exceeds a predetermined threshold Y1, a magnitude of a toothed rack force difference exceeds a predetermined threshold Z1, and a current vehicle speed exceeds a predetermined threshold Vspd1. As discussed above, powertrain torque is a signed variable. According to convention, powertrain torque effects caused by engine torque are positive, and powertrain torque effects caused by regenerative braking are negative. Similarly, acceleration is a signed variable.

If a determination is made that all of the conditions of operation 100 are met, then a torque steer control acceleration mode is activated at block 102. In this mode, a servomotor in a vehicle EPAS is commanded to provide torque to compensate the positive powertrain torque effects.

If a determination is made that not all of the conditions of operation 100 are met, then operation proceeds to operation 104. At operation 104, a determination is made of whether the current powertrain torque falls below a predetermined threshold X2, the vehicle acceleration falls below a predetermined threshold Y2, and the magnitude of the toothed rack force difference exceeds a predetermined threshold Z2. Threshold X2 is less than threshold X1 and threshold Y2 is less than threshold Y1.

If a determination is made that all of the conditions of operation 104 are met, then a torque steer control deceleration mode is activated at block 106. In this mode, a servomotor in a vehicle EPAS is commanded to provide torque to compensate the negative powertrain torque effects.

If a determination is made that not all of the conditions of operation 104 are met, then the operation ends at block 108.

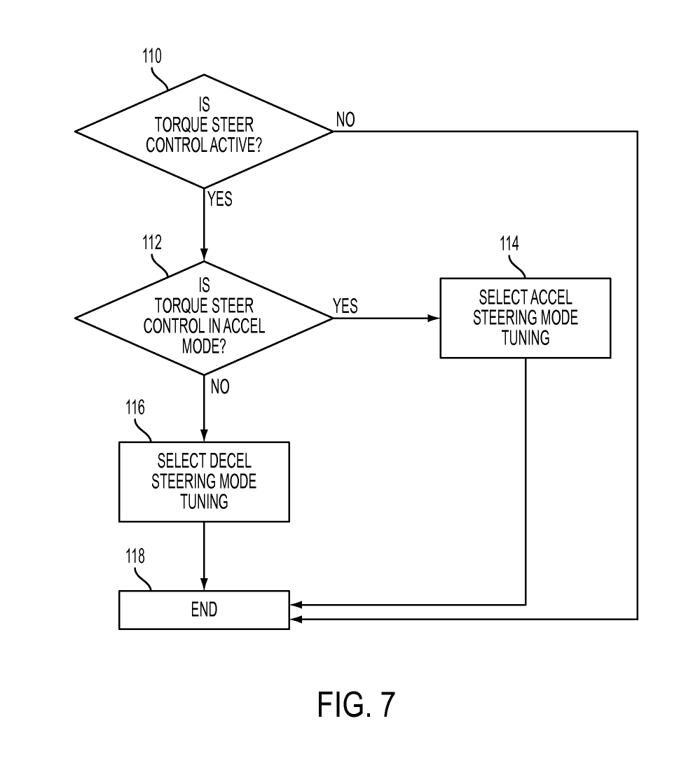

Referring now to FIG. 7, a flowchart illustrating another embodiment of steering control logic is shown. A determination is made of whether a torque steer control function is active, as illustrated at operation 110. This determination is made inclusively of both acceleration and deceleration modes. If a determination is made that torque steer control is not active, then the operation ends as illustrated at block 118. If a determination is made that torque steer control is active, then a determination is made of whether the torque steer control acceleration mode is active, as illustrated at operation 112. If yes, then an acceleration steering mode tuning is selected, as illustrated at block 114. When this tuning mode is active, a vehicle power steering system may be controlled to compensate for powertrain torque effects due to a vehicle engine. The operation then ends, as illustrated at block 118. Returning to operation 112, if a determination is made that the torque steer control is not in acceleration mode, then a deceleration steering mode tuning is selected, as illustrated at block 116. When this tuning mode is active, a vehicle power steering system may be controlled to compensate for powertrain torque effects due to regenerative braking. The operation then ends, as illustrated at block 118.

As can be seen from the various embodiments, certain systems and methods remove undesired drive influences caused by regenerative braking torque from a driver's perception without removing desired feedback from contact between vehicle traction wheels and the road.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of compensating for drive influences in a drive train of a vehicle equipped for regenerative braking and having a power steering system including a servomotor configured to provide torque to a vehicle steering rack, the method comprising:
commanding the servomotor to apply a compensation torque to the vehicle steering rack in response to a steering rack difference magnitude exceeding an associated threshold due to a regenerative braking event.

2. The method of claim 1, wherein commanding the servomotor to apply a compensation torque includes commanding the servomotor to apply a torque with magnitude to compensate a difference between a calculated setpoint force at the vehicle steering rack and a measured force at the vehicle steering rack.

3. The method of claim 1, wherein the commanding the servomotor is further in response to a predictive vehicle behavior model based on at least regenerative braking torque, wheel speed, steering rack force, and steering wheel angle.

4. The method of claim 1, wherein the associated threshold is a first predetermined threshold and the commanding the servomotor is further in response to a magnitude of powertrain torque exceeding a second predetermined threshold and a magnitude of vehicle acceleration exceeding a third predetermined threshold.

5. The method of claim 1, further comprising commanding the servomotor to apply a second compensation torque to the vehicle steering rack in response to the steering rack difference magnitude exceeding a second associated threshold due to an engine acceleration event.

6. A vehicle having:
a power steering system configured to provide torque to a vehicle steering rack;
a motor configured to apply regenerative braking torque to vehicle traction wheels; and
a controller configured to command the power steering system to provide a compensation torque in response to a steering rack difference magnitude exceeding an associated threshold due to a regenerative braking event.

7. The vehicle of claim 6, wherein the controller is further configured to predictively model vehicle behavior based on at least regenerative braking torque, wheel speed, steering rack force, and steering wheel angle.

8. The vehicle of claim 6, wherein the controller is configured to command the power steering system to apply a compensation torque with magnitude to compensate a difference between a calculated setpoint force at the vehicle steering rack and a measured force at the vehicle steering rack.

9. The vehicle of claim 6, wherein the associated threshold is a first predetermined threshold and the controller is further configured to command the power steering system to provide a compensation torque in response to a magnitude of vehicle acceleration exceeding a second predetermined threshold and a magnitude of powertrain torque exceeding a third predetermined threshold.

10. The vehicle of claim 6, wherein the controller is further configured to provide a second compensation torque in response to the steering rack difference magnitude exceeding a second associated threshold due to an engine acceleration event.

11. A method of controlling a power steering system in a vehicle having a motor configured to provide regenerative braking torque to vehicle traction wheels, the method comprising:
commanding the power steering system to provide a first compensation torque in response to a powertrain torque exceeding a first predetermined threshold and a magnitude of a steering rack force difference exceeding a second threshold, and
commanding the power steering system to provide a second compensation torque in response to the powertrain torque falling below a third predetermined threshold and the magnitude of the steering rack force difference exceeding a fourth predetermined threshold, wherein the steering rack force difference is the difference between a calculated steering rack setpoint force and a measured steering rack force and wherein the third threshold is less than the first threshold.

12. The method of claim 11, wherein the commanding the power steering to provide the first compensation torque is further in response to a vehicle acceleration exceeding a fifth predetermined threshold and a vehicle speed exceeding a sixth predetermined threshold and wherein the commanding the power steering to provide the second compensation torque is further in response to the vehicle acceleration falling below a seventh predetermined threshold, the seventh threshold being less than the fifth threshold.
